(19) United States
(12) Patent Application Publication
(10) Pub. No.: US 2007/0146150 A1
(43) Pub. Date: Jun. 28, 2007

(54) Carbon monoxide poisoning avoidance system

(76) Inventors: Gerry Calabrese, Fort Lauderdale, FL (US); Werner Stemer, Fort Lauderdale, FL (US)

Correspondence Address: LERNER GREENBERG STEMER LLP, P O BOX 2480, HOLLYWOOD, FL, 33022-2480, US

(21) Appl. No.: 11/316,558

(22) Filed: Dec. 22, 2005

(51) Int. Cl. G08B 17/10

(52) U.S. Cl. 340/632; 340/628

(57) ABSTRACT

An enclosed space, such as a garage, has a carbon monoxide detector. If an elevated level in the concentration of carbon monoxide (CO) is detected, an automatic closure is forced to open. In the case of a garage, the automatic garage door motor is energized upon detecting an unsafe level of CO. The forced opening may be overridden if smoke or a fire is detected.

### BACKGROUND OF THE INVENTION

### Field of the Invention

The invention relates to a safety device that aids in the avoidance of carbon monoxide poisoning.

Carbon monoxide (CO) is an odorless gas which, in extraneous concentrations, is deadly for humans. This is the reason that enclosed spaces which may be subject to high concentrations of carbon monoxide are often equipped with carbon monoxide (CO) detectors. Such spaces include garages and similar rooms that are exposed to exhaust gases from internal combustion engines.

Garages are often equipped with carbon monoxide detectors. On detecting an increased level in the concentration of CO which exceeds a predetermined threshold, the detector issues an audible alarm. Such an increased level of CO may be caused by operating an internal combustion engine (e.g., a car, a generator) inside the garage. By way of example, a tired driver may enter the garage, close the garage door by remote control, and then fall asleep at the wheel with the motor running. If the audible alarm is not able to wake the driver at that point, the driver may be subjected to severe carbon monoxide poisoning. A variety of similar situations in which the audible alarm may be overheard or may be intentionally disregarded, can lead to CO poisoning. That is, in some situations the audible alarm is simply not enough to provide for a sufficient safeguard against carbon monoxide poisoning.

### SUMMARY OF THE INVENTION

It is accordingly an object of the invention to provide a carbon monoxide poisoning avoidance system, which overcomes the above-mentioned disadvantages of the heretofore-known devices and methods of this general type and which provides for an additional, active safeguard against accidental carbon monoxide poisoning.

With the foregoing and other objects in view there is provided, in accordance with the invention, an enclosure assembly, comprising:

an enclosure substantially closing off an enclosed space and disposed to be moved between a closed position and an open position;

a motor connected to the enclosure and a switch connected to selectively energize the motor to move the enclosure into the open position; and

a carbon monoxide sensor connected and configured to energize the motor to automatically move the enclosure into the open position if an elevated level of carbon monoxide is detected.

In accordance with an added feature of the invention, the carbon monoxide sensor is connected in parallel with the switch. In a preferred implementation, there is also provided a smoke or fire detector connected to override the carbon monoxide sensor if smoke or a fire is detected. This prevents the door from opening and fanning a fire by supplying oxygen.

In accordance with a preferred feature of the invention, the enclosure is an automatic garage door and the enclosed space is a garage.

Other features which are considered as characteristic for the invention are set forth in the appended claims.

Although the invention is illustrated and described herein as embodied in a carbon monoxide poisoning avoidance system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a diagrammatic side view of a garage with an automatic garage door and a carbon monoxide poisoning avoidance system according to the invention; and

FIG. 2 is a simplified circuit diagram illustrating the electrical interconnections in the system.

### DESCRIPTION OF THE PREFERRED EMBODIMENTS

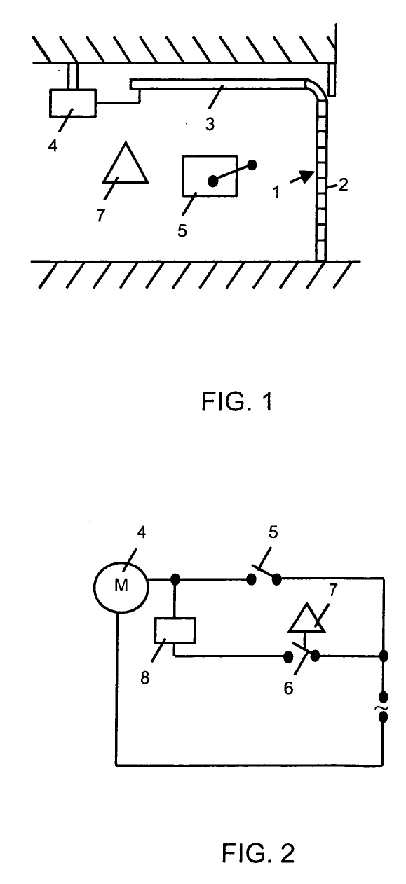

Referring now to the figures of the drawing in detail and first, particularly, to FIG. 1 thereof, there is seen a side view of a garage with an automatic garage door 1. The garage door 1 is formed of panels 2 that are pivotally connected to one another so as enable the door 1 to be pulled or pushed along guide rails 3. The guide rails 3 are arranged along the sidewalls of the garage. When the garage is open, the garage door 1 is disposed horizontally, i.e., parallel along the garage ceiling. An electric motor 4 is connected to the garage door 1 and it is energized to pull or push the door 1 between its open and closed positions.

The motor 4, in most household applications, is hardwired into the mains and it is energized by the household a.c. system. There is also typically provided a battery backup in the form of a UPS (uninterrupted power source) so as to assure that the door can still be opened if the mains power is out.

The motor 4 is controlled by a control panel which energizes the motor 4 as demanded through any of several switches. For example, the motor may be triggered by a remote control disposed in a vehicle or by a stationary switch 5 that is mounted to a wall of the garage.

The foregoing describes a conventional automatic garage door system. The invention resides in the addition of an override switch 6 that is triggered by a CO (carbon monoxide) detector 7. The detector 7 includes a CO sensor, a processor circuit, a power supply, and an audible horn, such as a piezo sounder. In accordance with the invention, the switch 6 is connected so that, as soon as the CO detector 7 “reports” dangerous levels of carbon monoxide, the motor 4 is energized to open the garage door. As long as the carbon monoxide is present at a concentration that would otherwise trigger a CO alarm, the switch 6 remains at the override position that holds the garage door open. Neither the manual switch 5 nor the remote control can be used to close the garage door 1.

It is, of course, possible to also override the switch 6. For example, in the case of a fire, it is advantageous not to open the garage door so as to supply extra oxygen and in fact fan the fire. For that purpose, a smoke detector and/or fire detector 8 may be connected into the circuit to block the bypass switch 6 from triggering the motor 4 to open the garage door 1.

The invention is particularly suited for retrofitting existing garage door systems. Conventional carbon monoxide detectors typically trigger an audible alarm if an elevated level of carbon monoxide is detected. The audible alarm is typically sounded by a piezo element which is energized through the circuit of the detector. The same output connection can be used to trigger the switch 6.

The invention as described herein is specifically directed to the avoidance of accidental poisoning by carbon monoxide that is caused when an internal combustion engine (e.g., automobile, power generator, etc.) is operated inside a garage. It will be understood, however, that the invention has a multitude of applications and potential implementations in a variety of environments. For example, the device for closing off a space may be a door, a window, or the like. Also, the closure of the space need not be absolute, in that slight leakage would still allow for the danger of extraneous carbon monoxide concentration levels.

We claim:

1. An enclosure assembly, comprising:
an enclosure substantially closing off an enclosed space and disposed to be moved between a closed position and an open position;
a motor connected to said enclosure and a switch connected to selectively energize said motor to move said enclosure into the open position; and
a carbon monoxide sensor connected and configured to energize said motor to automatically move said enclosure into the open position if an elevated level of carbon monoxide is detected.

2. The assembly according to claim 1, wherein said carbon monoxide sensor is connected in parallel with said switch.

3. The assembly according to claim 1, wherein said enclosure is an automatic garage door and said enclosed space is a garage.

4. The assembly according to claim 1, which further comprises a smoke or fire detector connected to override said carbon monoxide sensor if smoke or a fire is detected.

5. The assembly according to claim 4, wherein said carbon monoxide sensor is connected in parallel with said switch, and said smoke or fire detector is connected in series with said carbon monoxide sensor.
